(19) United States
(12) Patent Application Publication
(10) Pub. No.: US 2011/0099302 A1
(43) Pub. Date: Apr. 28, 2011

(54) CONTENT PROCESSING APPARATUS

(75) Inventor: Susumu OZEKI, Shijonawate-shi (JP)

(73) Assignee: SANYO ELECTRIC CO., LTD., Osaka (JP)

(21) Appl. No.: 12/912,327

(22) Filed: Oct. 26, 2010

(30) Foreign Application Priority Data
Oct. 26, 2009 (JP) 2009-245055

(51) Int. Cl. G06F 13/10

(52) U.S. Cl. 710/33

(57) ABSTRACT

A content processing apparatus includes a first transferor which transfers a predetermined content to an external device when accepting a transfer operation to any one of contents stored in a memory device. A predictor predicts a time period required for a transfer process of the content designated by the transfer operation, based on the time period taken for the transfer process of the first transferor and a size of the content designated by the transfer operation. A second transferor transfers the content designated by the transfer operation to the external device. A controller determines whether or not the time period predicted by the predictor falls below a reference based on a remaining amount of a battery, so as to permit a transfer process of the second transferor when the determined result is positive while restrict the transfer process of the second transferor when the determined result is negative.

### CROSS REFERENCE OF RELATED APPLICATION

The disclosure of Japanese Patent Application No. 2009-245055, which was filed on Oct. 26, 2009, is incorporated herein by reference.

### BACKGROUND OF THE INVENTION

1. Field of the Invention

The present invention relates to a content processing apparatus. More particularly, the present invention relates to a content processing apparatus which is applied to a digital video camera and transfers a content such image data to an external device.

2. Description of the Related Art

According to one example of this type of apparatus, an image signal outputted from an imaging unit of a digital camera is recorded on a recording unit. An image based on the image signal reproduced from the recording unit is displayed by a display unit. The image signal reproduced from the recording unit is also transmitted to a high-definition television by a wireless USB communication unit when a manual instruction operation is executed in a state where a battery has enough capacity.

However, in a case where a transmitting destination of the image signal is a server connected to a public telecommunication network such the Internet, a throughput of the image signal fluctuates because of a condition of access to the server, a traffic of a communication path to the server, a length of the communication path, a condition of an electric wave, and etc. On the assumption that the image signal is transmitted to such an external device, if it is determined whether or not a transmission process is available only based on a remaining capacity of the battery, such as in above-described apparatus, a power source may be turned off during the transmission process.

### SUMMARY OF THE INVENTION

A content processing apparatus according to the present invention, comprises: a first transferer which transfers a predetermined content to an external device when a transfer operation to any one of one or at least two contents stored in a recording medium is accepted; a predictor which predicts a time period required for a transfer process of the content designated by the transfer operation, based on a time period taken for a transfer process of the first transferer and a size of the content designated by the transfer operation; a second transferer which transfers the content designated by the transfer operation to the external device; and a controller which determines whether or not the time period predicted by the predictor falls below a reference based on a remaining amount of a battery, so as to permit the transfer process of the second transferer when the determined result is positive while restrict the transfer process of the second transferer when the determined result is negative.

A content processing program product executed by a processor of the content processing apparatus, comprises: a first transferring step which transfers the predetermined content to the external device when the transfer operation to any one of one or at least two contents stored in the recording medium is accepted; a predicting step which predicts the time period required for the transfer process of the content designated by the transfer operation, based on the time period taken for the transfer process of the first transferring step and the size of the content designated by the transfer operation; a second transferring step which transfers the content designated by the transfer operation to the external device; and a controlling step which determines whether or not the time period predicted by the predicting step falls below the reference based on the remaining amount of the battery, so as to permit the transfer process of the second transferring step when the determined result is positive while restrict the transfer process of the second transferring step when the determined result is negative.

A content processing method executed by the content processing apparatus, comprises: a first transferring step which transfers the predetermined content to the external device when the transfer operation to any one of one or at least two contents stored in the recording medium is accepted; a predicting step which predicts the time period required for the transfer process of content designated by the transfer operation, based on the time period taken for the transfer process of the first transferring step and the size of the content designated by the transfer operation; a second transferring step which transfers the content designated by the transfer operation to the external device; and a controlling step which determines whether or not the time period predicted by the predicting step falls below the reference based on the remaining amount of the battery, so as to permit the transfer process of the second transferring step when the determined result is positive while restrict the transfer process of the second transferring step when the determined result is negative.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of a connecting state of a digital video camera and a content server;

FIG. 4 is an illustrative view showing one example of an upload process of a dummy file;

FIG. 5 is an illustrative view showing another example of the upload process of the dummy file;

FIG. 6 is a flowchart showing one portion of behavior of a CPU applied to the embodiment in FIG. 2;

FIG. 7 is a flowchart showing another portion of the behavior of the CPU applied to the embodiment in FIG. 2;

FIG. 8 is a flowchart showing still another portion of the behavior of the CPU applied to the embodiment in FIG. 2;

FIG. 9 is a flowchart showing yet another portion of the behavior of the CPU applied to the embodiment in FIG. 2;

FIG. 10 is a flowchart showing another portion of the behavior of the CPU applied to the embodiment in FIG. 2;

FIG. 11 is a flowchart showing still another portion of the behavior of the CPU applied to the embodiment in FIG. 2;

### DETAILED DESCRIPTION OF THE PREFERRED EMBODIMENTS

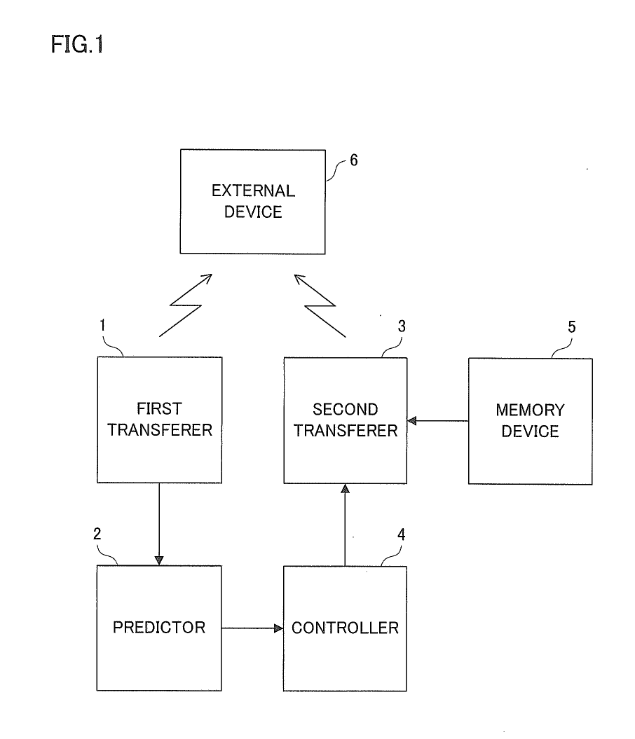

With reference to FIG. 1, a content processing apparatus of one embodiment of the present invention is basically configured as follows: A first transferer 1 transfers a predetermined content to an external device 6 when a transfer operation to any one of one or at least two contents stored in a memory device 5 is accepted. A predictor 2 predicts a time period required for a transfer process of the content designated by the transfer operation, based on the time period taken for the transfer process of the first transferer 1 and a size of the content designated by the transfer operation. A second transferer 3 transfers the content designated by the transfer operation to the external device 6. A controller 4 determines whether or not the time period predicted by the predictor 2 falls below a reference based on a remaining amount of a battery, so as to permit a transfer process of the second transferer 3 when the determined result is positive while restrict the transfer process of the second transferer 3 when the determined result is negative.

Therefore, when the transfer operation is performed, the predetermined content is transferred to the external device 6 before the designated content is transferred. The time period required for the transfer process of the designated content is predicted based on the time period taken for the transfer process of the predetermined content and the size of the designated content. The transfer process of the designated content is permitted when the predicted time period falls below the reference based on the remaining amount of the battery, while it is restricted when the predicted time period is equal to or more than the reference based on the remaining amount of the battery. Permitting or restricting the transfer process of the designated content with reference to the reference based on the remaining amount of the battery enables to avoid a situation where a power source is turned off during transferring of the designated content

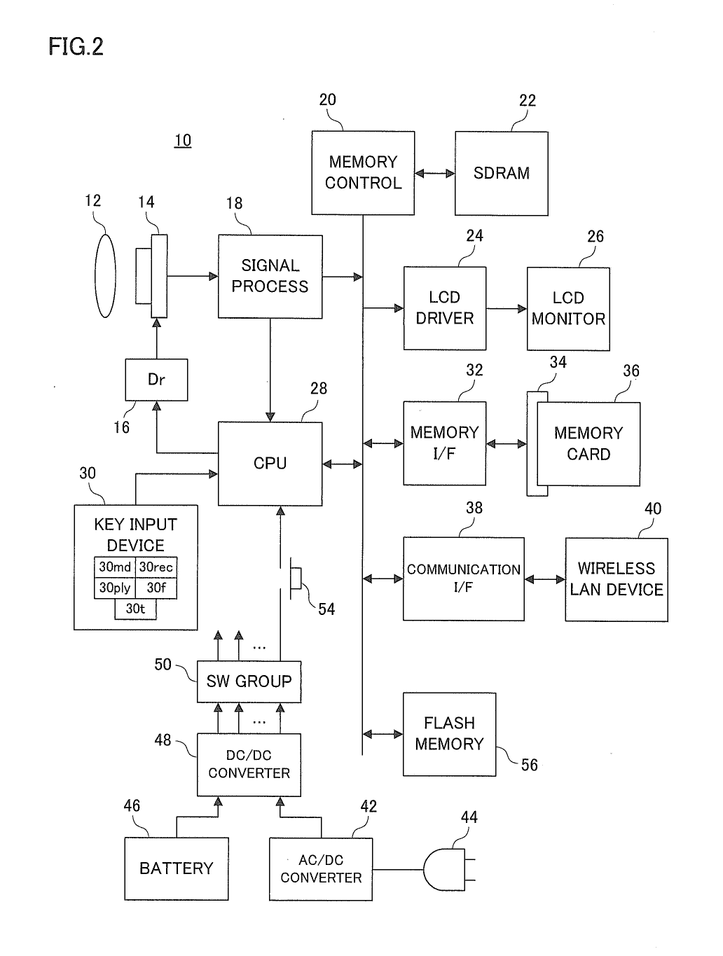

With reference to FIG. 2, a digital video camera 10 according to this embodiment includes an optical lens 12. An optical image of an object scene enters, with irradiation, an imaging surface of an image sensor 14 via the optical lens 12 and is subjected to a photoelectric conversion. Thereby, electric charges representing an object scene image are produced.

The digital video camera 10 also includes a plug 44 to connect to a commercial AC power source. An AC voltage provided through the plug 44 is converted by an AC/DC converter 42 into a DC voltage, and the converted DC voltage is provided to a DC/DC converter 48. To the DC/DC converter 48, the DC voltage outputted from a battery 46 is provided.

The DC/DC converter 48 converts the DC voltage provided from the AC/DC converter 42 into a plurality of DC voltages different from each other when the plug 44 is connected to the commercial AC power source, and converts the DC voltage provided from the battery 46 into the plurality of DC voltages different from each other when the plug 44 is shut down from the commercial AC power source. The plurality of converted DC voltages are provided to the whole system via SW group 50.

When a power source button 54 is operated, a portion of the DC voltages converted by the DC/DC converter 46 is provided to a CPU 28, and thereby, the CPU 28 is started up. The CPU 28 starts up an imaging task when a camera mode is selected by a mode setting switch 30md arranged in a key input device 30 and starts up a reproducing task when a reproduction mode is selected by the same mode setting switch 30md.

When the imaging task is started up, the CPU 28 starts up a driver 16 for a moving image fetching process. In response to a vertical synchronization signal Vsync generated periodically, the driver 16 exposes the imaging surface and reads out the electric charges produced on the imaging surface in a raster scanning manner. From the image sensor 14, raw image data representing the object scene is outputted repeatedly.

A signal processing circuit 18 performs processes, such as a white balance adjustment, a color separation and a YUV conversion, on the raw image data outputted from the image sensor 14, and writes the created YUV-formatted image data into an SDRAM 22 through a memory control circuit 20. An LCD driver 24 reads out the image data accommodated in the SDRAM 22 through the memory control circuit 20, and drives an LCD monitor 26 based on the read-out image data. As a result, a real-time moving image (through image) of the object scene is displayed on a monitor screen.

When a recording start operation is performed by a recording button 30rec arranged in the key input device 30, the CPU 28 commands a memory I/F 32 to start a recording process. The memory I/F 32 newly creates a moving-image file in a memory card 36, repeatedly reads out the image data accommodated in the SDRAM 22 through the memory control circuit 20, and writes the read-out image data into the created moving-image file.

When a recording end operation is performed by the recording button 30rec, the CPU 28 commands the memory I/F 32 to end the recording process. The memory I/F 32 ends to read out the image data from the SDRAM 22, and performs an end process on the moving-image file of a writing destination.

It is noted that the memory card 36 is removable, and is accessed by the memory I/F 32 when it is attached to a slot 34.

When the reproducing task is started up, the CPU 28 designates the moving-image file recorded in the memory card 36, and commands the memory 1/F 32 to reproduce a head frame image. The memory I/F 32 reads out a head-frame image data from a designated moving image file, and writes the read-out image data into the SDRAM 22 through the memory control circuit 20.

The LCD driver 24 reads out the image data accommodated in the SDRAM 22 through the memory control circuit 20, and chives the LCD monitor 26 based on the read-out image data. As a result, the head frame image is displayed on the LCD monitor 26.

When a reproducing start operation is performed by a reproducing button 30ply arranged in the key input device 30, the CPU 28 commands the memory I/F 32 to start moving-image reproducing. The memory I/F 32 periodically reads out a plurality of frames of image data accommodated in the designated moving-image file, and writes the read-out image data into SDRAM 22 through the memory control circuit 20. The image data accommodated in the SDRAM 22 is read out by the LCD driver 24, and as a result, the moving image is displayed on the LCD monitor 26.

When a reproducing end operation is performed by the reproducing button 30ply or the reproduced image reaches an end frame image in the designated moving-image file, the CPU 28 commands the memory I/F 32 to end moving-image reproducing, and further commands the memory 1/F 32 to reproduce the head frame image. As a result, the head frame image in the designated moving-image file is displayed on the LCD monitor 26 again.

When a forwarding operation is performed by a forwarding button 30f arranged in the key input device 30, the CPU 28 designates a subsequent image file and commands the memory I/F 32 to reproduce the head frame image. The memory I/F 32 executes the same process as above described, and thereby, the head frame image accommodated in the subsequent moving-image file is displayed on the LCD monitor 26.

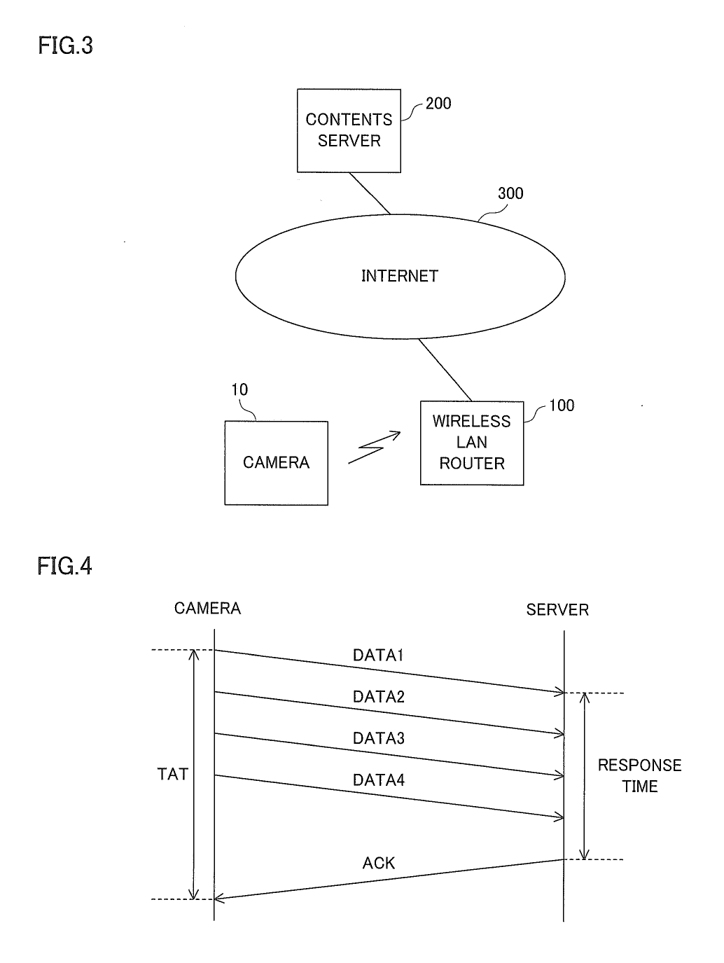

When an upload operation is performed by a transfer button 30t arranged in the key input device 30, the CPU 28 executes an upload process following TCP/IP via a wireless LAN router 100 so as to upload the designated moving-image file to a contents server 200 connected to the Internet 300 shown in FIG. 3.

However, as a throughput of the moving-image file fluctuates according to a condition of access to the contents server 200, a traffic of a communication path to the content server, a length of the communication path, a condition of an electric wave and etc., if a drive power source of the digital video camera 10 is the battery 46, depending on the remaining capacity of the battery 46, a power source may be turned off during the upload process.

Therefore, in a case where the drive power source of the digital video camera 10 is the battery 46, the CPU 28 calculates a required time period to transfer the designated moving-image file (=expected transfer time period Tc) and an available time period to continuously reproduce the moving-image file memorized in the memory card 36 (=continuously reproducible time period Tp) before the upload process. The continuously reproducible time period Tp is calculated with reference to the remaining amount of the battery 46. Herein, the continuously reproducible time period Tp is the time period that is able to reproduce the moving-image file continuously under the reproduction mode, and by adding a consumed power required at a time of transmission using a wireless LAN device 40, an electric power required for the upload process is considered in calculating the continuously reproducible time period Tp.

Moreover, the CPU 28 determines whether or not the expected transfer time period Tc falls below the continuously reproducible time period Tp, so as to permit the upload process when Tc<Tp is established , while restrict or prohibit the upload process when Tc≧Tp is established. When the upload process is prohibited, the CPU 28 notifies an operator of an upload being unavailable.

Thus, the upload process is permitted or restricted with reference to the reference based on the remaining amount of the battery 46. Thereby, this enables to avoid a situation where the power source is turned off during the upload of the designated moving-image file. Moreover, by executing the calculating process in order from the expected transfer time period Tc to the continuously reproducible time period Tp, it becomes possible to calculate the continuously reproducible time period Tp based on the electric power consumed for calculating the expected transfer time period Tc, and therefore, an accuracy of the calculated continuously reproducible time period Tp is improved.

The expected transfer time period Tc is calculated with the following procedure. Firstly, the CPU 28 commands a communication I/F 38 to transmit a user ID and a password. The communication I/F 38 transmits the user ID and the password to the contents server 200 through the wireless LAN device 40.

The contents server 200 executes a verification process referring to the transmitted user ID and password, and returns a verification result indicating any one of “OK” and “NG” to the transmission source of the user ID and the password. The returned verification result is received by the wireless LAN device 40, and is given to the CPU 28 via the communication I/F 38.

When the verification result indicates “NG”, the CPU 28 notifies the operator of a verification having been failed. On the other hand, when the verification result indicates “OK”, the CPU 28 acquires a verification token, and commands the communication I/F 38 to upload a dummy file. The communication I/F 38 adds the acquired verification token to the dummy file, and uploads the dummy file with the verification token to the contents server 200 through the wireless LAN device 40.

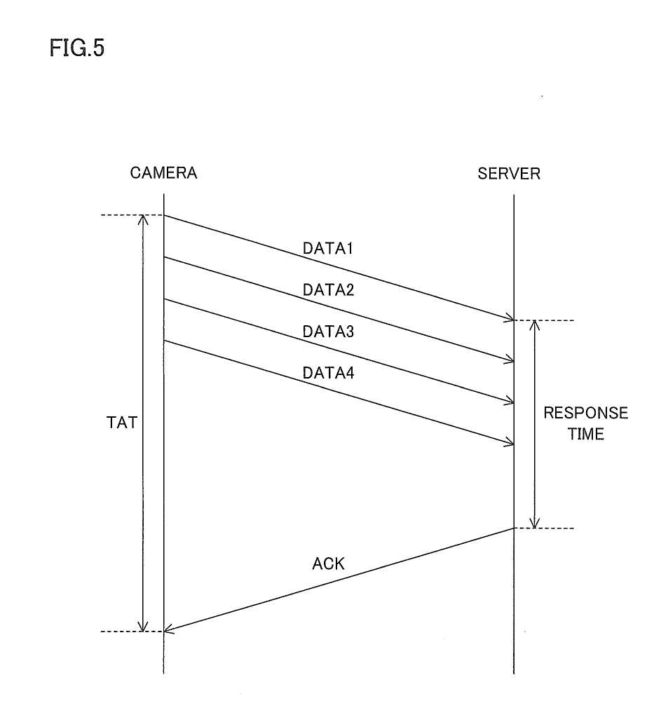

The size of the dummy file is smaller enough than the expected minimum size of the moving-image file, and is specifically equivalent to a TCP transmission window size. The TCP transmission window size is N times greater (N: an integer of two or more and N=4 in this embodiment) than an MSS(Maximum Segment Size), and the dummy file is divided into data 1 to data 4, and is uploaded with the procedure shown in FIG. 4 and FIG. 5.

The contents server 200 stores the uploaded dummy file in an internal storage, and concurrently, returns an ACK signal to the transmission source of the dummy file in response to a completion of receiving data up to data 4 (see FIG. 4 or FIG. 5). The returned verification result is received by the wireless LAN device 40 and is given to the CPU 28 via the communication I/F 38.

When the ACK signal is received, the CPU 28 measures the throughput (unit: bps) of the dummy file with reference to Equation 1. When a time period from a timing of starting transmission of the data 1 to a timing of receiving the ACK signal is defined as “TAT”, the throughput is obtained by dividing a numerical value which is N times of the MSS by the time period TAT. It is noted that “TAT” stands for a turnaround time and means a time period from transmitting a request to receiving a response. For reference, a time period from a recipient receiving the request to the recipient outputting a response is called a response time.

Throughput=MSS×N/TAT [Equation 1]

The throughput reflects the condition of access to the contents server 200, the traffic of a communication path to the contents server 200, the length of the communication path, the condition of the electric wave and etc. Comparing FIG. 4 with FIG. 5, both the traffic and the condition of access to the contents server 200 shown in FIG. 5 are more crowded, and the time TAT shown in FIG. 5 is also longer. Thus, the throughput calculated in a situation of FIG. 5 is lower than the throughput calculated in a situation of FIG. 4.

Upon completion of the measurement of the throughput, the CPU 28 commands the communication I/F 38 to issue a delete request so as to delete the dummy file from the contents server 200. The communication I/F 38 creates the delete request in which the acquired verification token and file information of the dummy file are described, and transmits the created delete request to the contents server 200 through the wireless LAN device 40. As a result, the dummy file is deleted from the storage of the contents server 200.

Then, the CPU 28 acquires a size of the designated moving-image file, and calculates the expected transfer time period Tc according to Equation 2. According to Equation 2, the expected transfer time period Tc is obtained by dividing the size of the moving-image file by the throughput of the dummy file.

Expected transfer time period Tc=Size of the moving-image file/throughput of the dummy file [Equation 2]

The continuously reproducible time period Tp is calculated with the following procedure. Firstly, the CPU 28 detects a terminal voltage of the battery 46, and calculates an electric energy of the battery 46 according to Equation 3. Furthermore, the CPU 28 calculates an input power of the digital video camera 10 in the reproduction mode according to Equation 4, and calculates the continuously reproducible time period according to Equation 5.

Electric energy of the battery 46=Terminal voltage of the battery 46×Discharged capacity of the battery 46×Discharged efficiency of the battery 46 [Equation 4]

Input power of the digital video camera 10 in the reproduction mode=Load power of the digital video camera 10 in the reproduction mode/Power conversion efficiency of the digital video camera 10 in the reproduction mode

The continuously reproducible time period Tp=Electric energy of the battery 46/Input power of the digital video camera 10 in the reproduction mode [Equation 5]

According to Equation 3, the electric energy of the battery 46 is obtained by mutually multiplying by the terminal voltage, the discharged capacity, and the discharged efficiency of the battery 46. According to Equation 4, the input power of the digital video camera 10 in the reproduction mode is obtained by dividing the load power of the digital video camera 10 in the reproduction mode by the power conversion efficiency of the digital video camera 10 in the reproduction mode. According to Equation 5, the continuously reproducible time period Tp is obtained by dividing the electric energy of the battery 46 by the input power of the digital video camera 10 in the reproduction mode.

It is noted that the load power of the digital video camera 10 in the reproduction mode is acquired by adding a margin a to a consumed power of the CPU 28, the LCD driver 24, the LCD monitor 26, the communication I/F 38 and the wireless LAN device 40.

For example, in a case where the TCP transmission window size is 5840 (=1460×4) bytes and the time period TAT is 48 mm seconds, if one byte is equal to eight bits, the throughput becomes 973333 bps. That is, the throughput becomes approximately 1 Mbps (=125

Kbytes/second). In a case where the moving-image file in size of 800 Mbytes is uploaded on this condition, the expected transfer time period Tc becomes about 6400 seconds (=800000 Kbytes/124 Kbytes/second).

In a case where the terminal voltage, the discharged capacity, and the discharged efficiency of the battery 46 are 3.7 volts, 740 mAh and 90%, respectively, the electric energy of the battery 46 becomes 2.4642 Wh (=3.7×0.74×0.9). However, when the terminal voltage of the battery 46 is decreased to 2.3 volts, the electric energy of the battery 46 is reduced to 1.5318 Wh (=2.3×0.74×0.9).

Moreover, in a case where the load power of the digital video camera 10 in the reproduction mode is 0.91225 watts and the power conversion efficiency of the digital video camera 10 in the reproduction mode is 79%, the input power of the digital video camera 10 in the reproduction mode becomes 1.154746 watts (=0.91225/0.79).

Then, the continuously reproducible time period Tp in a case where the terminal voltage of the battery 46 is 3.7 volt which is corresponding to a full charged condition becomes 7682 seconds, and therefore, it is determined that the moving-image file in size of 800 Mbytes is transferable. On the other hand, the continuously reproducible time period Tp in a case where the terminal voltage of the battery 46 is decreased to 2.3 volts becomes 4773 seconds, and therefore, it is determined that the moving-image file in size of 800 Mbytes is untransferable.

The upload process of the designated moving-image file is executed with the following procedure. Firstly, the CPU 28 commands the communication I/F 38 to transmit the user ID and the password. The communication I/F 38 transmit the user ID and the password to the contents server 200 through the wireless LAN device 40.

The contents server 200 executes the verification process referring to the transmitted user ID and password, and returns the verification result indicating either “OK” or “NG” to the transmission source of the user ID and the password. The returned verification result is received by the wireless LAN device 40, and is given to the CPU 28 via the communication I/F 38.

When the verification result indicates “NG”, the CPU 28 notifies an operator of the verification having been failed. On the other hand, when the verification result indicates “OK”, the CPU 28 acquires the verification token, and commands the communication I/F 38 to upload the designated moving-image file. The communication I/F 38 adds the acquired verification token to the designated moving-image file, and uploads the designated moving-image file with the verification token to the contents server 200 through the wireless LAN device 40.

The contents server 200 stores the uploaded designated-moving-image file in the internal storage, and concurrently, returns the acknowledge signal ACK to the transmission source of the designated moving-image file in response to the completion of uploading the designated moving-image file. The returned acknowledge signal ACK is received by the wireless LAN device 40 and is given to the CPU 28 via the communication I/F 38. The CPU 28 ends the upload process in response to the receiving of the acknowledge signal ACK.

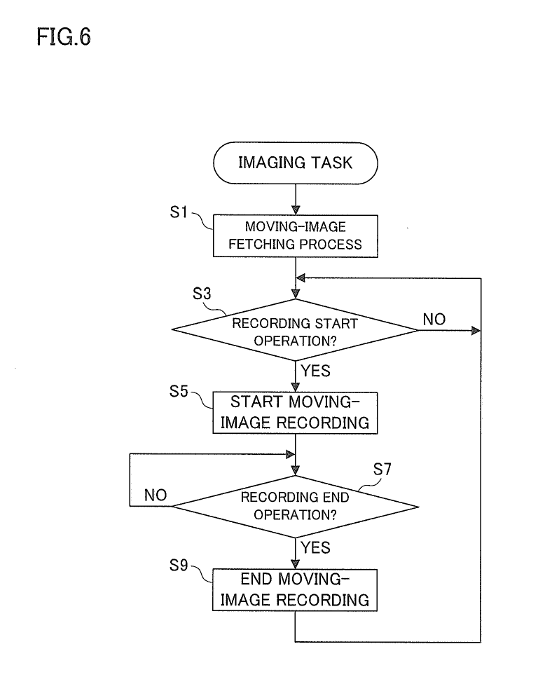

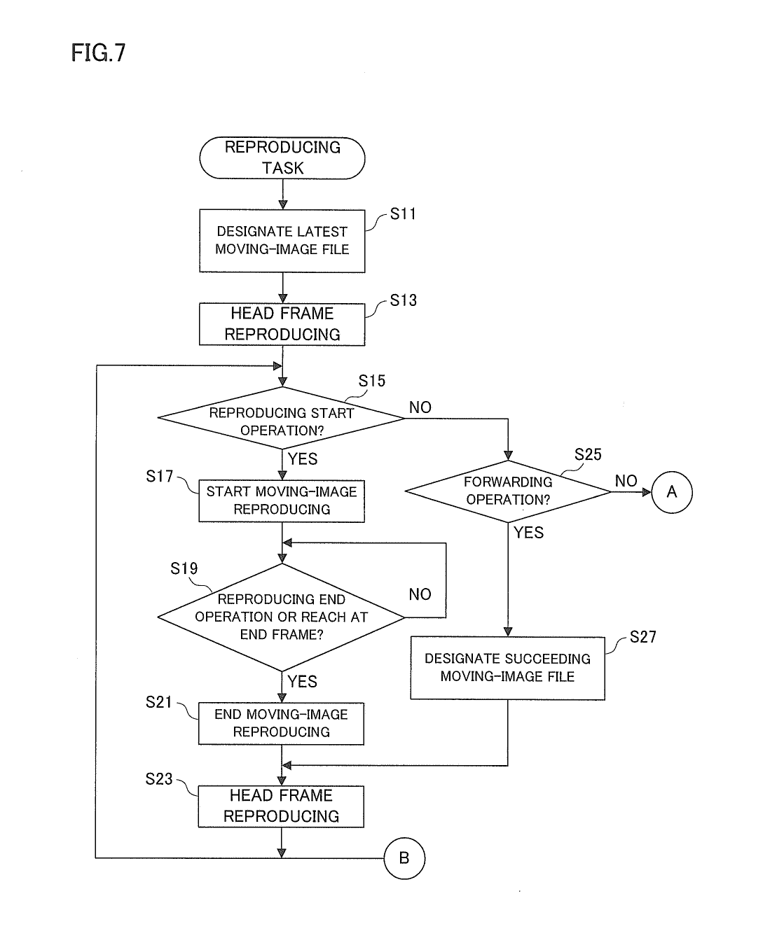

The CPU 28 executes a plurality of tasks including an imaging task shown in FIG. 6 and a reproducing task shown in FIG. 7 to FIG. 11, in a parallel manner. It is noted that control programs corresponding to these tasks are memorized in a flash memory 56.

With reference to FIG. 6, in a step S1, a moving-image fetching process is executed. As a result, a through image is displayed on the LCD monitor 26. In a step S3, it is repeatedly determined whether or not the recording-start operation is performed. When a determined result is updated from NO to YES, the process advances to a step S5 so as to command the memory I/F 32 to start the recording process. As a result, the moving-image file is created in the memory card 36, and the image data is accumulated in the moving-image file.

In a step S7, it is repeatedly determined whether or not the recording-end operation is performed. When a determined result is updated from NO to YES, the process advances to a step S9 so as to command the memory I/F 32 to end the recording process. As a result, the moving-image file of the accumulation destination of the image data is closed. Upon completion of the process in the step S9, the process returns to the step S3.

With reference to FIG. 7, in a step S11, the latest moving-image file recorded in the memory card 36 is designated, and in a step S13, the I/F 32 is commanded to reproduce the head frame image. As a result, the head frame image of the designated moving-image file is displayed on the LCD monitor 26. In a step S15, it is determined whether or not the reproducing start operation is performed, in a step S25, it is determined whether or not the forwarding operation is performed, and in a step S29, it is determined whether or not the uploading operation is performed.

When the reproducing start operation is performed, the process advances from the step S15 to a step S17 so as to command the memory I/F 32 to start the moving-image reproduction. As a result, the moving image accommodated in the designated moving-image file is displayed on the LCD monitor 26.

In a step S19, it is repeatedly determined whether or not an OR condition under which the reproducing end operation is performed or the reproduced image reaches the end frame image is satisfied. When a determined result is updated from NO to YES, the memory OF 32 is commanded to end the moving-image reproduction in a step S21, and the process similar to that in above-described step S13 is executed in a step S23. As a result, the head frame image of the designated moving-image file is once again displayed on the LCD monitor 26. Upon completion of the process in the step S23, the process returns to the step S15.

If the forwarding operation is performed in a state where the head frame image is displayed, YES is determined in a step S25, and a subsequent moving-image file is designated in a step 27, and then the process advances to a step S23. As a result, the head frame image of the subsequent moving-image file is displayed on the LCD monitor 26.

If the uploading operation is performed in a state where the head frame image is displayed, YES is determined in a step S29, and it is determined in a step S31 whether the drive power source of the digital video camera 10 is the commercial AC power source or the battery 46. If the drive power source is determined as the commercial AC power source, the process returns to the step 15 via the upload process in a step S33. If the drive power source is determined as the battery 46, the process returns to the step 15 via the processes in steps S35 to S43.

In the step S35, an expected transfer time period calculating process is executed, and in the step 37, a continuously reproducible time period calculating process is executed. Thereby, the above-described expected transfer time period Tc and continuously reproducible time period Tp are obtained. In the step S39, it is determined whether or not the expected transfer time period Tc falls below the continuously reproducible time period Tp, and if the determined result is YES, the upload process is executed in the step 41 while if determined result is NO, the operator is notified of the upload being unavailable in the step S43.

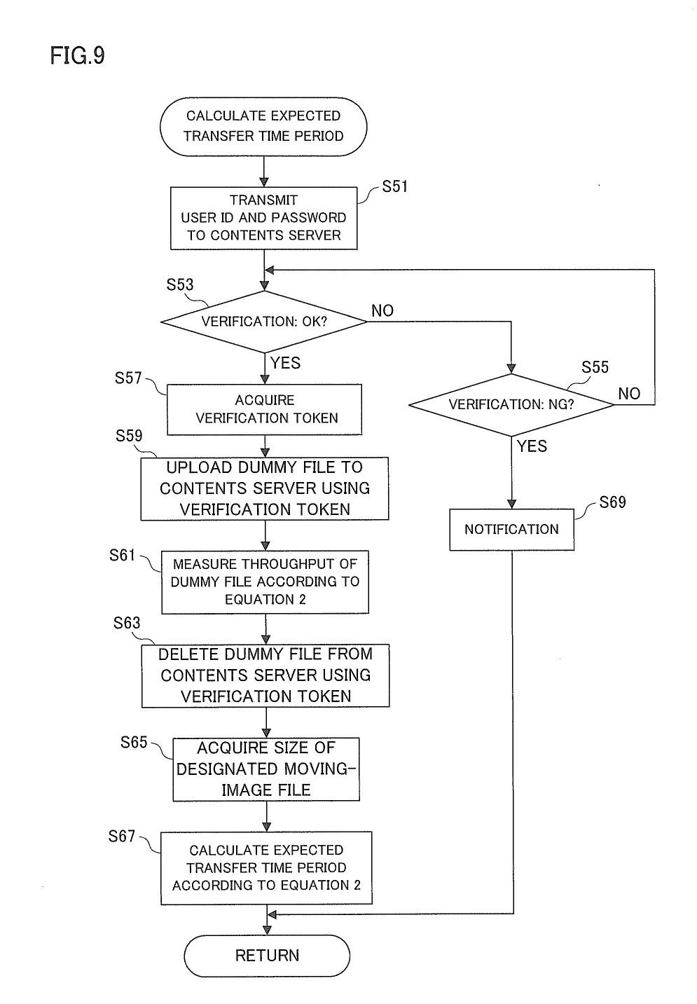

The expected transfer time period calculating process in the step S35 is executed according to a subroutine shown in FIG. 9. Firstly, in a step S51, the communication I/F 38 is commanded to transmit the user ID and the password. The user ID and the password are transmitted to the contents server 200 through the wireless LAN device 40.

In a step S53, it is determined whether or not the verification result indicating “OK” is returned from the contents server 200, and in a step S55, it is determined whether or not the verification result indicating “NG” is returned from the contents server 200.

When YES is determined in the step S55, the operator is notified of the verification having been failed in a step S69, and thereafter, the process returns to the routine in an upper hierarchy. If the determined result is YES in the step S53, the process advances to a step S57.

In the step S57, the verification token is acquired, and in a step S59, the communication I/F 38 is commanded to upload the dummy file. As a result, the dummy file with the verification token is uploaded to the contents server 200 through the wireless LAN device 40.

In a step S61, the throughput of the dummy file is measured in response to the return of the acknowledge signal ACK from the contents server 200. When the measurement of the throughput is completed, the communication I/F is commanded to issue the delete requirement so as to delete the dummy file. As a result, the dummy file is deleted from the storage of the contents server 200.

When the process in a step S63 is completed, the size of the designated moving-image file is acquired in a step S65, and the expected transfer time period Tc is calculated according to Equation 1 in a step S67. Upon completion of the process in the step S67, the process returns to the routine in the upper hierarchy.

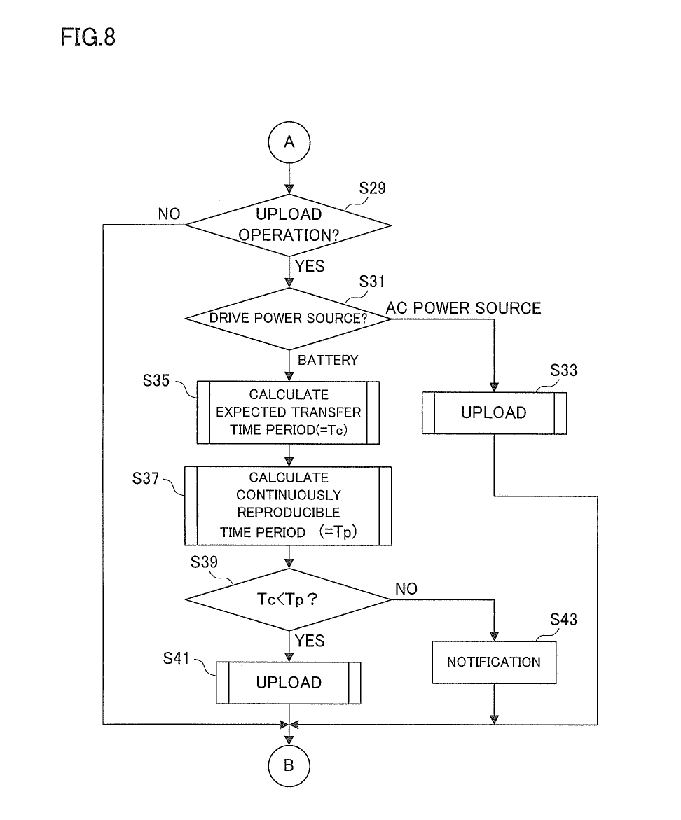

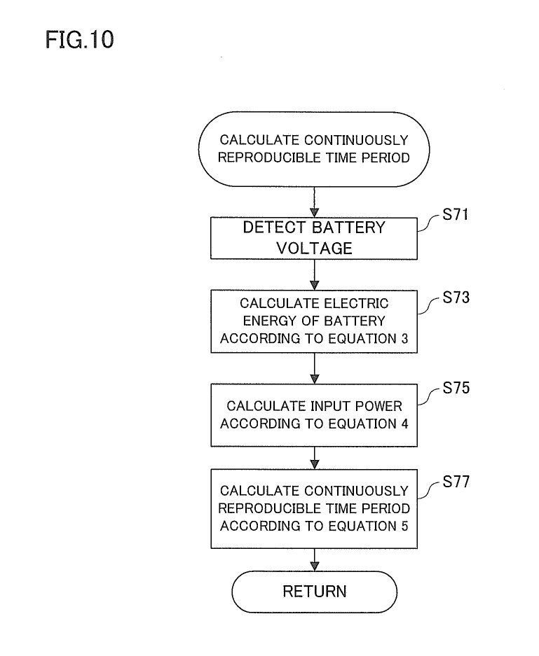

The continuously reproducible time period calculating process in the step S37 shown in FIG. 8 is executed according to subroutine shown in FIG. 10. Firstly, the terminal voltage of the battery 46 is detected in a step S71. In a step S73, the electric energy of the battery 46 is calculated according to Equation 2, and in a step S75, the input power of the digital video camera 10 in the reproduction mode is calculated according to Equation 3, and in a step S77, the continuously reproducible time period Tp is calculated according to Equation 4. Upon completion of the process in the step S77, the process returns to the routine in the upper hierarchy.

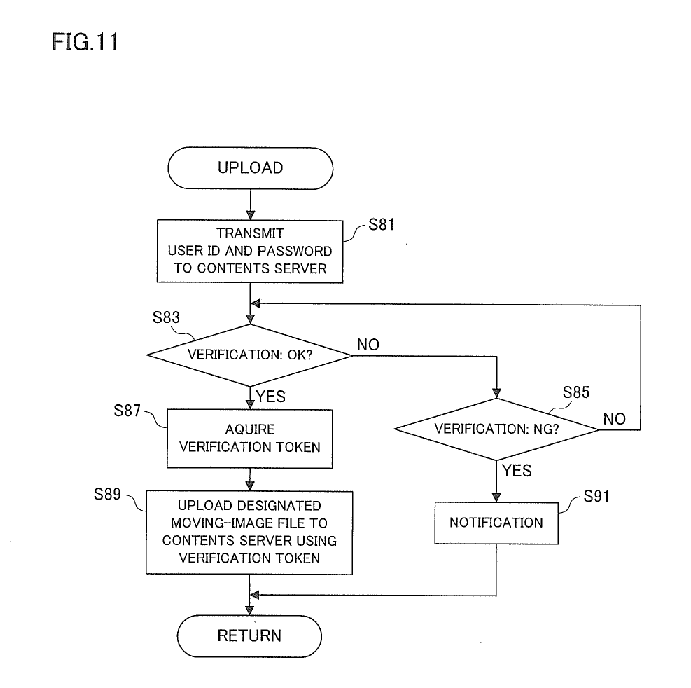

The upload process in the step S33 or S41 shown in FIG. 8 is executed according to a subroutine shown in FIG. 11. However, processes in steps S81 to S87 and S91 are the same as the processes in steps S51 to S57 and S69, and therefore, a duplicated explanation is omitted.

In a step S89 following the step S87, the communication I/F 38 is commanded to upload the designated moving-image file. As a result, the designated moving-image file with the verification token is uploaded to the contents server 200 through the wireless LAN device 40. Returning to the routine in the upper hierarchy is executed in response to receiving the acknowledge signal ACK from the contents server 200.

As can be seen from the above-described explanation, when the transfer operation to designate any one of one or at least two moving-image files stored in the memory card 36 is accepted, the CPU 28 uploads the dummy file to the contents server 200 (S59). Moreover, the CPU 28 predicts the time period required for uploading the designated moving-image file based on the time period taken for uploading of the dummy file and the size of the designated moving-image file (S35), and permits or restricts the upload process of the designated moving-image file corresponding to a magnitude relation between the predicted time period and the reference based on the remaining amount of the battery (S39). The upload process of the designated moving-image file is permitted when the predicted time period falls below the reference based on the remaining amount of the battery while it is restricted when the predicted time period is equal to or more than the reference based on the remaining amount of the battery.

Thus, permitting or restricting the upload process with reference to the reference based on the remaining amount of the battery enables to avoid the situation where the power source is turned off during the upload of the designated moving-image file.

It is noted that in this embodiment, the moving-image is recorded onto the memory card; however, instead of the moving image, or in addition to the moving image, a still image may be recorded onto the memory card. Moreover, in this embodiment, the memory card and the wireless LAN device are separately independent; however, the memory card and the wireless LAN device may be united. Furthermore, in this embodiment, the moving image is assumed as the content to be uploaded; however, instead of the moving image, or in addition to the moving image, content such as a still image or a sound may be uploaded.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A content processing apparatus, comprising:
a first transferer which transfers a predetermined content to an external device when a transfer operation to any one of one or at least two contents stored in a recording medium is accepted;
a predictor which predicts a time period required for a transfer process of the content designated by the transfer operation, based on a time period taken for a transfer process of said first transferer and a size of the content designated by the transfer operation;
a second transferer which transfers the content designated by the transfer operation to said external device; and
a controller which determines whether or not the time period predicted by said predictor falls below a reference based on a remaining amount of a battery, so as to permit a transfer process of said second transferer when the determined result is positive while restrict the transfer process of said second transferer when the determined result is negative.

2. A content processing apparatus according to claim 1, further comprising a reproducer which reproduces any one of one or at least two contents stored in said recording medium in response to a reproduce operation, wherein the reference is equivalent to a continuously reproducible time period of said reproducer.

3. A content processing apparatus according to claim 2, wherein said reproducer executes a reproducing process when said first transferer and said second transferer are suspending the transfer processes.

4. A content processing apparatus according to claim 1, wherein said predictor includes an eraser which erases the predetermined content from said external device.

5. A content processing apparatus according to claim 1, wherein each of said first tranferer and said second transferer executes a transfer process every segment having a unit size, and said predetermined content has a size which is N times (N: an integer of two or more) of the unit size and falls below a minimum size of the content being transferred by said second transfrerer.

6. A content processing program product executed by a processor of a content processing apparatus, the program product comprising:
a first transferring step which transfers a predetermined content to an external device when a transfer operation to any one of one or at least two contents stored in a recording medium is accepted;
a predicting step which predicts a time period required for a transfer process of the content designated by the transfer operation, based on a time period taken for a transfer process of said first transferring step and a size of the content designated by the transfer operation;
a second transferring step which transfers the content designated by the transfer operation to said external device; and
a controlling step which determines whether or not the time period predicted by said predicting step falls below a reference based on remaining amount of the battery, so as to permit a transfer process of said second transferring step when the determined result is positive while restrict the transfer process of said second transferring step when the determined result is negative.

7. A content processing method executed by a content processing apparatus, the method comprising:
a first transferring step which transfers a predetermined content to an external device when a transfer operation to any one of one or at least two contents stored in a recording medium is accepted;
a predicting step which predicts a time period required for a transfer process of the content designated by the transfer operation, based on a time period taken for a transfer process of said first transferring step and a size of the content designated by the transfer operation;
a second transferring step which transfers the content designated by the transfer operation to said external device; and
a controlling step which determines whether or not the time period predicted by said predicting step falls below a reference based on the remaining amount of the battery, so as to permit a transfer process of said second transferring step when the determined result is positive while restrict the transfer process of said second transferring step when the determined result is negative.
